(19) United States
(12) Patent Application Publication
(10) Pub. No.: US 2007/0188841 A1
(43) Pub. Date: Aug. 16, 2007

(54) Method and system for lowering the drive potential of an electrochromic device

(75) Inventors: Martin Moeller, Dublin (IE); Nikolaos Vlachopoulos, Dublin (IE); David Mulroy, Dublin (IE); David Corr, Dublin (IE)

Correspondence Address: Dainel H. Golub, 1701 Market Street, Philadelphia, PA, 19103, US

(73) Assignee: NTERA, Inc.

(21) Appl. No.: 11/351,579

(22) Filed: Feb. 10, 2006

(51) Int. Cl. G02F 1/15

(52) U.S. Cl. 359/265

(57) ABSTRACT

An electrochromic (EC) device having a low starting potential, thereby having a lower drive potential is disclosed. A potential is applied to the EC device to lower the starting potential. Methods and systems for manufacturing EC devices and adjusting the drive potential of an existing EC device are also disclosed.

### BACKGROUND OF THE INVENTION

Electrochromic (EC) devices are a type of electro-optic device using EC materials and a pair of electrodes. When a voltage is applied between the electrodes, the oxidation/reduction state of the EC materials changes, thus causing the color of the EC device to change. As used herein, the phrase color change (and the term colorization) is meant to include any changes in the absorption/reflection spectrum, to include changes in light intensity.

EC materials are typically disposed between the two electrodes. EC materials can be in liquid or solid form. In one type of EC device, EC materials are coated on the surface of one of the electrodes. The electrochromic electrode, a second electrode and an electrolyte disposed between the two electrodes form an EC cell.

For an EC cell, there is a starting potential, which represents the difference between the potential of the two electrodes. In order to change the color of the EC cell, a drive voltage, termed as drive potential, is applied between the electrodes away from the starting potential of the EC cell, thereby changing the reduction/oxidation (redox) state of the EC materials. The drive potential generally has a magnitude at least equal to or greater than the magnitude of the starting potential. Generally, the magnitude of the minimum drive potential is equal to the magnitude of the starting potential. The lower the starting potential, the lower the drive potential needed to achieve the same degree of color change in the EC cell.

The starting potential may be dependent on electrode materials used, electrochromic materials used, concentration of the electrochromic materials, stability of the electrochromic materials, chemical reaction occurrence in the EC cell, gas or other kinds of physical, chemical and/or electrical barrier formation on the surfaces of the electrodes, configuration of the EC cell, manufacturing processes, temperature, electrolyte materials, impurities, exposure to light, length of use, and other parameters generally known to those skilled in the art.

Lowering the starting potential lowers the drive potential required to achieve the same electrochemical changes in the EC device and can have other benefits to the device's stability during its operational lifetime.

During manufacturing of EC devices, the starting potentials of the EC cells are difficult to control. For mass production of EC devices, it is preferable for the EC devices to have substantially constant starting potentials, which results in a constant drive potential that can be applied to the EC devices to achieve a certain contrast ratio. In other words, consistency of products is preferred. Therefore, there is a need for a method to control the starting potential of the EC cells.

It is preferable to operate an EC device at a low drive potential. Low drive potential prevents the occurrence of irreversible electrochemical reactions, thereby prolonging the life of the EC device. Lower drive potentials are also preferred for fast switching speed between color changes, low voltage and current demands on driving circuits, and ease in making imaging devices, such as higher density of cells, flexibility for designing pixel sizes, etc.

It is an object of the invention to provide an electrochromic device having a low starting potential, which can be operated at a low drive potential.

It is a further object of the invention to provide an electrochromic device having a high contrast ratio at a low drive potential.

It is also an object of the invention to provide a method of manufacturing an electrochromic device having a low starting potential.

It is a further object of the invention to provide a method of manufacturing of an electrochromic device having a high contrast ratio at a low drive potential.

It is a further object of the invention to provide a method for lowering the starting potential of an existing electrochromic device to enable it to operate at a low drive potential.

It is a further object of the invention to provide a method of manufacturing electrochromic devices with consistent operational parameters.

### BRIEF SUMMARY OF THE INVENTION

The present invention includes an electrochromic (EC) device suitable for low drive potentials with high contrast ratio. The device comprises a first electrode, a second electrode, and an electrolyte. The device further comprises an electrochromic material disposed between the electrodes. Preferably, the EC material is coated on one of the electrodes.

The present invention also includes an EC device having a controllable starting potential. Preferably, the starting potential is lowered.

The present invention also includes an EC device that retains its colorization for greater length of time after adjustment of the drive potential.

The present invention further includes a method for manufacturing an EC device with controllable drive potential. In a preferred embodiment, a potential is applied between the electrodes of the EC device to achieve a desired starting potential. Preferably, the drive potential is capable of being lowered.

The present invention further includes a method for manufacturing EC devices with consistency of starting potentials among the EC devices.

The present invention further includes a method for adjusting the starting potential of an EC device. The adjustment of the starting potential can be performed either locally or remotely using an electrical potential.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the Drawings:

FIG. 1 illustrates an electrochromic device in accordance with a preferred embodiment the present invention;

FIG. 2 is a graph illustrating contrast ratios before and after a positive potential is applied to an electrochromic device in accordance with the present invention;

FIG. 3. is a use case diagram for a system to adjust starting potential and drive potential of an electrochromic device in accordance with the present invention;

FIG. 4. is a class diagram containing attributes of an electrochromic device in accordance with the present invention;

FIG. 5. is a flow diagram of a process for adjusting starting potential and drive potential of an electrochromic device in accordance with the present invention; and

FIG. 6. is a block diagram of a system with a wired or wireless network connection for adjusting starting potential and drive potential of an electrochromic device in accordance with the present invention.

### DETAILED DESCRIPTION OF THE INVENTION

Certain terminology is used herein for convenience only and is not to be taken as a limitation on the present invention. In the drawings, the same reference letters are employed for designating the same elements throughout the several figures. The words “right”, “left”, “lower” and “upper” designate directions in the drawings to which reference is made. The words “inwardly” and “outwardly” refer to directions toward and away from, respectively, the geometric center of the electrochromic device and designated parts thereof. The terminology includes the words above specifically mentioned, derivatives thereof and words of similar import.

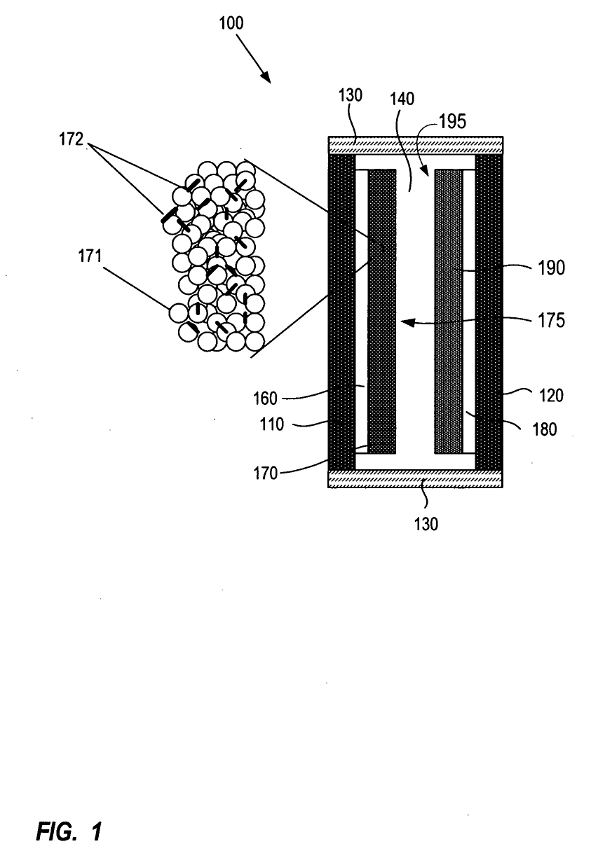

FIG. 1 illustrates the structure of an Electrochromic (EC) device 100 in accordance with the present invention. EC device 100 preferably comprises a first substrate 110 and a second substrate 120 at least one of which has either translucent or transparent properties. The other substrate 110, 120 may have transparent, translucent or opaque properties. Typical substrates can be made of glass, plastic or ceramic materials of any other material generally known in the art. The two substrates 110, 120 are preferably sealed around the edges with epoxy resin 130 to hold electrolyte 140. Other types of sealants may include thermoplastic synthetic resin and synthetic rubber.

Electrolyte 140 can be in gel, polymer or liquid form. Optionally, electrolyte 140 can be in molten form or in solution in a solvent. Suitable electrolytes are disclosed in U.S. Pat. Nos. 6,301,038; 6,870,657; and 6,950,220, the entire disclosures of which are incorporated herein by reference. The electrolyte 140 preferably comprises at least one electrochemically inert salt. Preferably, Lithium perchlorate is used. However, examples of suitable salts include hexafluorophosphate, bis-trifluoromethanesulfonate, bis-trifluoromethylsulfonylamidure, tetraalkylammonium, dialkyl-1, and 3-imidazolium. Examples of suitable molten salts include, 1 butyl-1-methylpyrrolidinium bis-(trifluoromethylsulfonyl)imide, 1-ethyl-3-methyl imidazolium bis-(trifluoromethylsulfonyl)imide and 1-propyldimethyl imidazolium bis-(trifluoromethylsulfonyl)imide. The solvent may be any suitable solvent and is preferably selected from acetonitrile, butyronitrile, glutaronitrile, dimethylsulfoxide, dimethylformamide, dimethylacetamide, N-methyloxazolidinone, dimethyl-tetrahydropyrimidinone, gamma-butyrolactone and mixtures thereof.

First and second substrates 110, 120 are preferably coated with first and second conductive metal oxide layers 160, 180, respectively, of fluorine doped tin oxide (FTO) or indium tin oxide (ITO).

Preferably, a nanoporous nanocrystalline film 170 is deposited on top of the conductive metal oxide layer 160 of substrate 110. Film 170 comprises a semiconductive metallic oxide 171 having a redox chromophore 172 adsorbed thereto.

The electrically conducting or semiconducting material preferably comprises nanoparticles of a metal oxide 171, the most preferred of which is titanium dioxide. The electrochromic material 172 is most preferably a viologen adsorbed to the nanoparticles of the metal oxide 171. Suitable viologens are disclosed in U.S. Pat. Nos. 6,301,038, 6,605,239, 6,755,993, 6,861,014 and 6,870,657, and International Patent Application Publication No. WO-A-04/67673, the entire disclosures of which are incorporated herein by reference.

Semiconductive metallic oxide 171 is preferably made of TiO₂, WO₃, MoO₃, ZnO or SnO₂. However, those skilled in the art will understand that the semiconductive metallic oxide 171 may be an oxide of any suitable metal, such as, for example, titanium, zirconium, hafnium, chromium, molybdenum, tungsten, vanadium, niobium, tantalum, silver, zinc, strontium, iron (Fe²⁺ or Fe³⁺) or nickel or a perovskite thereof.

Redox chromophore 172 may be any suitable redox chromophore and preferably comprises a compound of the general formula

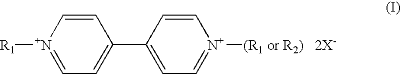

where X is a charge balancing ion such as a ion such as a halide;

where R₁ is any one of the following:

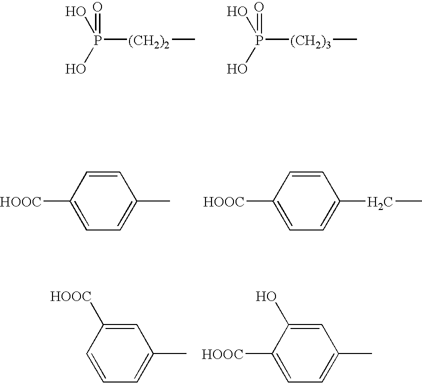

and where R₂ is any one of the following:

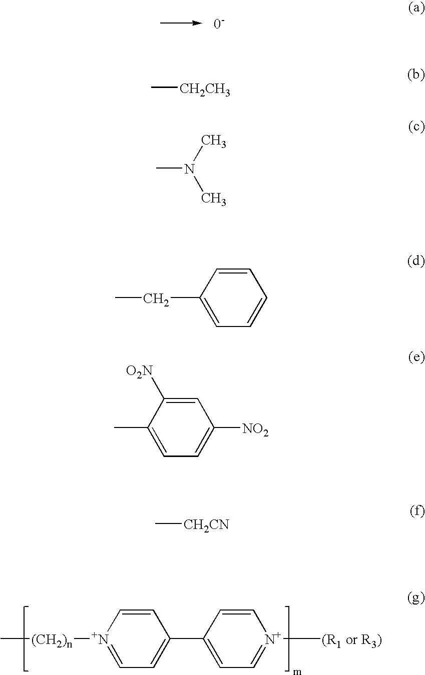

where R₁ is as defined above, R₃ is any of the formulae (a) to (f) given above under R₂, m is an integer of from 1 to 6, preferably 1 or 2 and n is an integer from 1 to 10, preferably 1 to 5.

A preferred redox chromophore 172 is a compound of formula II, viz. bis-(2-phosphonoethyl)-4,4′-bipyridinium dichloride:

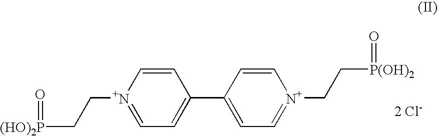

Preferably, a bipolarisable layer 190 is deposited on top of the second conductive metal oxide layer 180 of substrate 120. The layer 190 is preferably an Antimony-doped Tin Oxide (ATO). However, those skilled in the art will recognize that the layer 190 could be any material capable of developing a capacitance, such as metal oxides (like ATO), carbon and conducting polymers.

The first and second conductive metal oxide layers 160, 180 in combination with the nanocrystalline film 170 and bipolarisable layer 190, respectively, serve as first and second electrodes 175, 195 for the EC device 100. These electrochromic electrodes 175, 195 are preferably of the type described in U.S. Pat. Nos. 6,301,038 and 6,870,657, and International Patent Application Publication No. WO-A-04/68231, the entire disclosures of which are incorporated herein by reference.

Although the foregoing description describes one type of EC device 100 used in accordance with the present invention, a number of other structures can be utilized to create the EC device 100 and may result in different placement of the electrodes, additional nanostructure layers, different types of electrolytes and electrochromophores and electrochromophore mixtures. Thus, the present method and system are not limited to any particular EC device architecture, but apply generally to all EC devices in which a redox reaction occurs.

When an EC cell is formed, it has a starting potential. Changing one of the parameters that affects the starting potential, including but not limited to, gas accumulation on surfaces of the electrodes, barrier layers formed on the electrodes, electrode potentials, activity of the electrochromic materials, and complex formation of the electrolyte and electrochromic materials, may lower or increase the starting potential. Applying an electrical potential to the EC cell is a preferred means to effect a change in the starting potential.

In a typical application of the EC device 100, a negative potential is applied between the first electrode 175 and the second electrode 195. When the applied potential is greater than the starting potential, the redox state changes, resulting color change or colorization of the EC cell.

If a positive potential, i.e. a potential greater than zero, is applied between the first and second electrodes 175, 195 of the EC device 100, the starting potential of the device will be lowered, thereby allowing the device to achieve the same colorization while operating at a lower drive potential.

Lowering the drive potential of the EC device 100 has the effect of increasing the memory capacity of the electrodes 175, 195 of the EC device 100. That is, at the lower drive potential, leakage current of the EC device 100 is reduced, thereby allowing the electrodes 175, 195 to remain at their designated charge level for a greater length of time. As such, the EC device 100 retains its desired level of colorization for a longer period of time.

Moreover, lowering the drive potential of the EC device 100 permits overall lower power consumption of the EC device 100. Additionally, increasing memory of the electrodes 175, 195 also lowers power consumption, since time between charge cycles is increased, thereby necessitating less power being consumed by the EC device 100.

The method of using a positive potential to lower the starting potential, thereby enabling an EC device to be operated at a lower drive potential, while achieving the same contrast ratio, is illustrated in the following example.

In one embodiment four (4) EC devices were prepared, each comprising a first electrode, i.e. a mesoporous TiO₂ layer with surface confined viologen molecules on conducting glass, a second electrode comprising a mesoporous ATO on conducting glass with an overcoated white reflector and an electrolyte solution (1M LiN(SO₂CF₃)₂/water). The conducting layer of the electrochromic electrode was divided into independently addressable segments and each of the segments was partly coated with TiO₂/viologen. The gap between the two electrodes, which were disposed parallel to one another and aligned with one another, was about 60 μm and the active electrode area was about 25 cm².

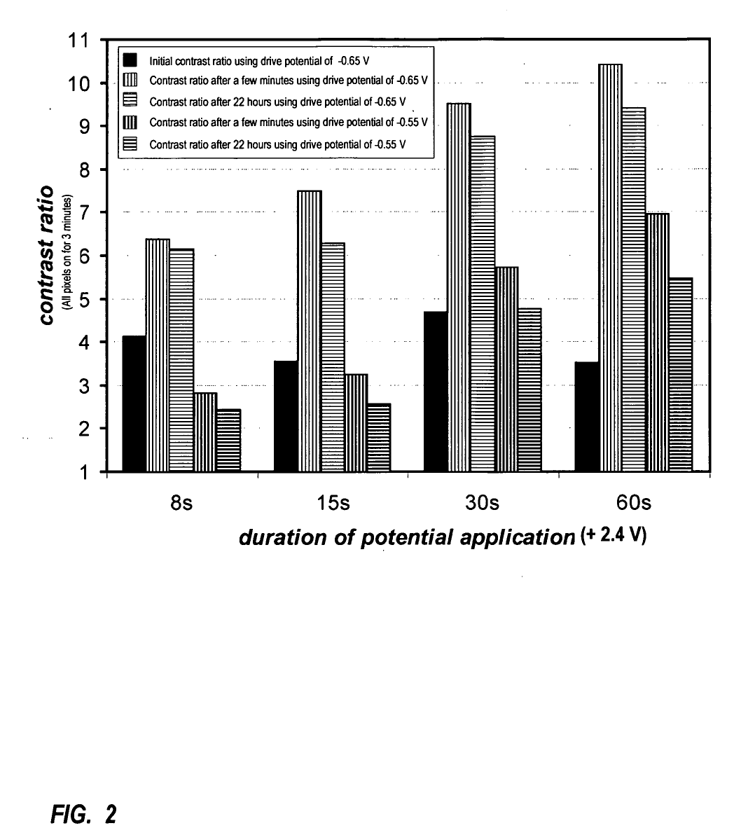

Referring to FIG. 2, the contrast ratio of the four (4) devices was measured initially at a drive potential of −0.65 V. Subsequently, a potential of +2.4 V between the first and second electrodes was applied to each device, but with different durations: 8 s on the first device, 15 s on the second device, 30 s on the third device and 60 s on the fourth device. A few minutes after this treatment, the contrast ratio of each device was measured at two different drive potentials, i.e. −0.55 V and −0.65 V. After 22 h at open circuit in the decoloured state, the contrast ratios with different drive potentials were measured again. Each of the four devices showed a higher contrast ratio at −0.65 V directly after the potential application and after storage. Each device showed a proportionately lower contrast ratio at −0.55 V. The device which had the potential applied for 30 s showed almost the same contrast ratio at −0.55 V as before the treatment at −0.65 V. Thus, the application of a positive potential can (a) generate a higher contrast level for the same drive potential; or (b) lower the starting potential, or lower the required overvoltage, thereby lowering the drive potential, while achieving the same level of contrast.

One aspect of the present method and system is to provide an electrochromic device having a high contrast ratio comprising a first electrode, a second electrode, an electrolyte, and means for applying a potential greater than zero between the first and second electrodes.

Another aspect of the present method and system is to provide an electrochromic device having a low drive potential comprising a first electrode, a second electrode, an electrolyte, and means for applying a potential greater than zero between the first and second electrodes.

Yet another aspect of the present method and system is to provide a method for lowering the drive potential of an electrochromic device comprising a first electrode, a second electrode, and an electrolyte, the method comprising applying a potential greater than zero between the first and second electrodes.

The potential applied between the first and second electrodes should be sufficient to lower the drive potential but not damage the first and second electrodes 175, 195. The potential applied is preferably from about +0.1 to about +10 V, more preferably from about +0.5 to about +5 V, and most preferably from about +1.5 to about +3 V.

The positive potential is typically applied between the first and second electrodes for a period ranging from about a few milliseconds to about 5 minutes. It will be appreciated that similar results can be achieved by applying a high voltage for a short period of time or a lower voltage for a longer period of time. That is, the voltage and duration of the applied potential can be varied according to a monotonically decreasing relationship between voltage and duration in which an increase in duration allows for a decrease in voltage. In one embodiment the duration can be varied from about a few milliseconds to about 5 minutes with the voltage varying from about +/−0.1 V to about +/−10 V. In other embodiments, different ranges of voltages and durations can be utilized to create the monotonically decreasing relationship between voltage and duration.

In one embodiment, the potential applied between the first and second electrodes is a varying waveform. That is, the applied potential varies with time.

Although the invention has been described with respect to potentials and currents induced by those potentials, other techniques can be used to activate the materials. These techniques can include the use of plasmas and electric and magnetic fields.

In the present method and system, the starting potential, thereby the overvoltage and drive potential, of an electrochromic device is preferably lowered by at least about 10 mV, more preferably by at least about 1 V, and most preferably by at least about 2 V.

The drive potential of an electrochromic device of the present invention is preferably in the range of from about −3 to about +3 V, more preferably from about −1.5 to about +1.5 V, and most preferably from about −0.8 to about +0.8 V.

The present method and system may be used for manufacturing an electrochromic device having a low starting potential, or manufacturing an electrochromic device having a high contrast ratio at a low drive potential, or for adjusting/lowering the starting potential of an existing electrochromic device to enable it to be operated at a desired drive potential.

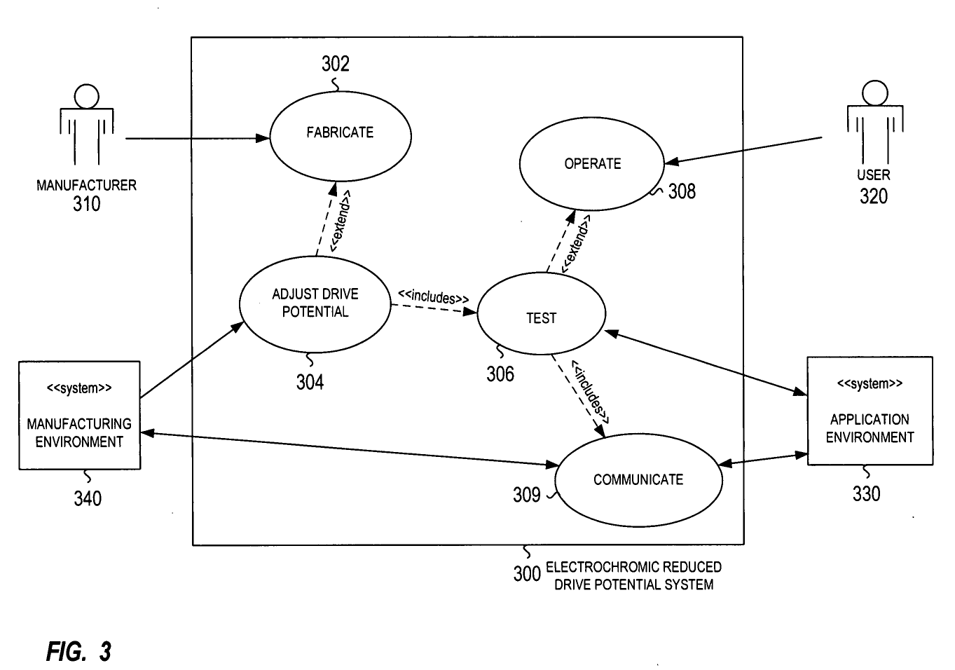

FIG. 3 illustrates a Unified Modeling Language (“UML”) use-case diagram for an electrochromic reduced drive potential system for manufacturing EC devices 100 having low starting potentials, and adjusting an existing EC device 100 to achieve a desired starting potential and associated systems and actors in accordance with the present method and system. UML can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the present method and system, but do not constrain its implementation to any particular hardware or software embodiments. Unless otherwise noted, the notation used with respect to the UML diagrams contained herein is consistent with the UML 2.0 specification or variants thereof and is understood by those skilled in the art.

The electrochromic reduced drive potential system 300 comprises a fabricate use case 302, an adjust drive potential use case 304, a test use case 306, an operate use case 308, and a communicate use case 309.

A manufacturer 310 preferably uses the system 300 for making an EC device 100 having a low drive potential, the method comprising the following steps:

(a) assembling a first electrode, a second electrode, and an electrolyte to form an electrochromic device as in the fabricate use case 302; and

(b) applying a potential greater than zero between the first and second electrodes so as to lower the drive potential of the electrochromic device, and/or incorporating in the device means for applying said potential between the first and second electrodes in the adjust drive potential use case 304.

The manufacturing process further comprises testing of the drive potential to achieve a certain level of contrast, which represents a test of the starting potential in the test use case 306. The fabricate use case 302 and test use case 306 may also be adjusted in the manufacturing environment 340. The communicate use case 309 can enable tools for local or remote adjusting. As an example, an electronic test set up can be incorporated into the manufacturing environment 340, with the test results being reported to one or more circuits in manufacturing environment 340. Communicate use case 309 can be invoked to cause the manufacturing environment 340 to report the test results and cause further adjustment of the starting and/or drive potential.

The circuits and systems for applying the potential after manufacture may be incorporated in the device or in electronics associated with the device. Such circuits and systems typically comprise computer software and associated electronics which may be included in the EC device and which will enable the desired potential to be applied before and after the electrochromic device is used. In one embodiment, the electrochromic reduced drive potential system 300 communicates with the application environment (e.g. display, camera, thermostat, or other device incorporating the electrochromic reduced drive potential system 300) 330 which communicates results regarding contrast (e.g. test results) and which allows for adjustment of the starting and/or drive potential through the adjust drive potential use case 304 in the application environment 330. This feature allows for modification of the drive potential in the application environment 330, and can be used to restore contrast if there have been changes in the EC over time. In one embodiment the application environment 330 communicates with remotely located equipment (not shown) to determine the appropriate potential and duration of application of that potential.

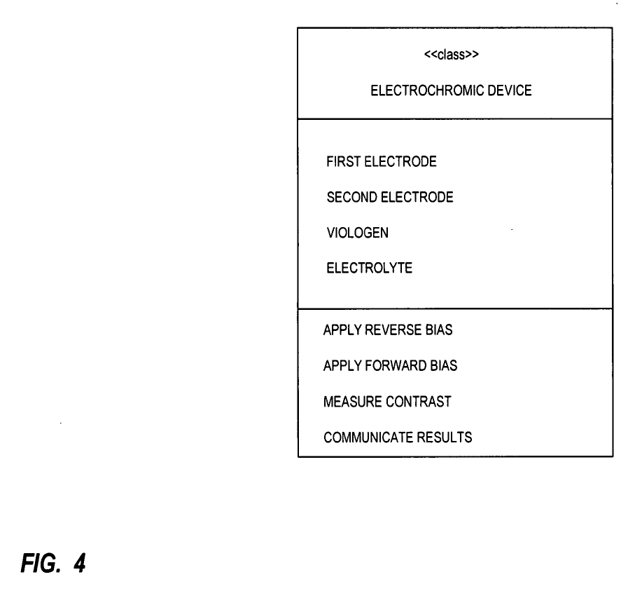

The attributes and operations of an EC device in accordance with the present method and system are illustrated in a class diagram in FIG. 4. The class diagram is also considered as part of the UML and can be used to better describe the EC device 100.

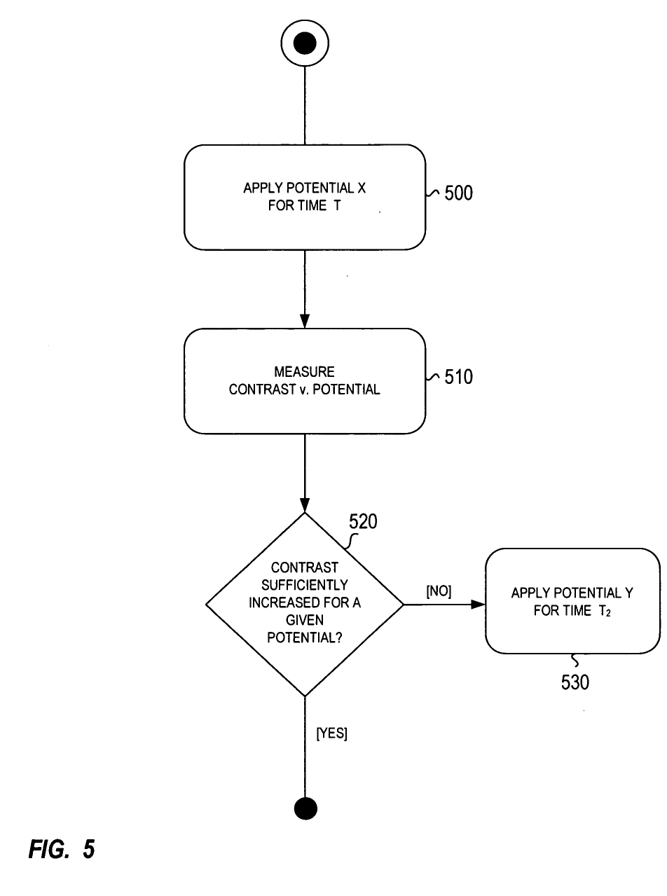

Referring to FIG. 5, the process of applying a potential to adjust the starting and/or drive potential in accordance with the present method and system is shown. As illustrated in FIG. 5, a potential is applied in apply potential X step 500, with a measurement of the contrast v. potential being obtained in measure step 510. The contrast can be tested in test step 520, and if it is determined that an insufficient potential has been applied, an additional potential is applied in apply potential Y step 530.

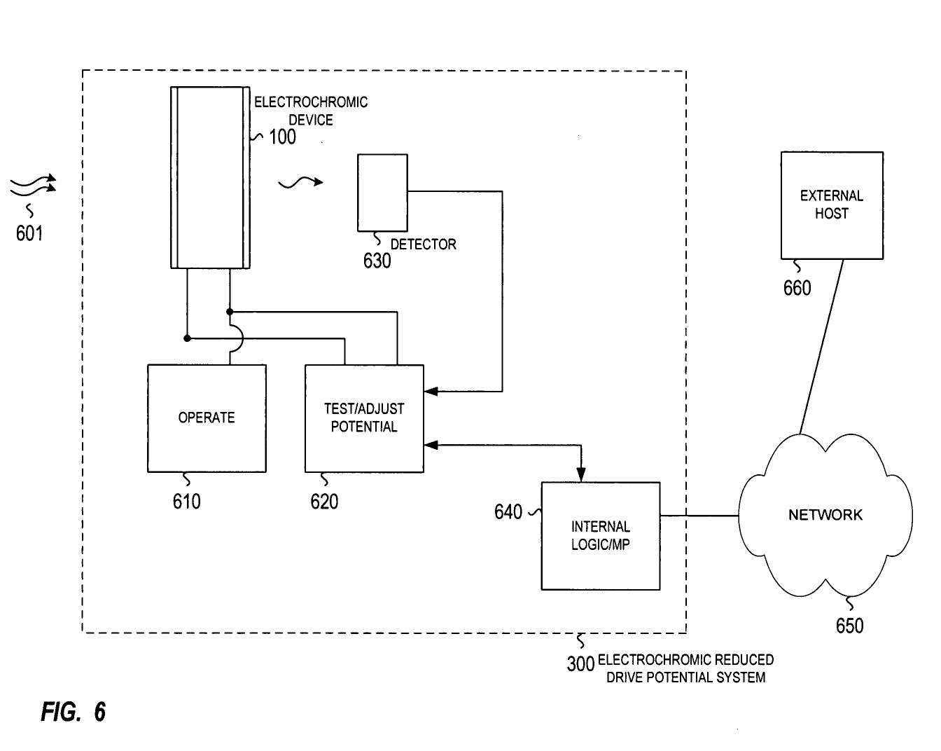

Referring to FIG. 6, an architecture for changing starting potential in the electrochromic reduced drive potential system 300 is shown. As shown in FIG. 6, incident light 601 passes through EC device 100 and strikes detector 630. Test/adjust potential module 620 reports the measured light and drive voltage to internal logic 640, which in one embodiment is a microprocessor. Based on the results, an additional potential can be applied for a specified amount of time as determined by internal logic 640 working in conjunction with test/adjust potential module 620. Once the potential has been successfully applied, the operating voltage applied from operate module 610 can be reduced if possible, or maintained to achieve a greater contrast. In the event that the potential application is not successful in reducing the operating voltage, internal logic 640 can increase the operating voltage to achieve greater contrast.

As illustrated in FIG. 6, the electrochromic reduced drive potential system 300 may communicate with a wired or wireless network 650 to provide remote access for a manufacturer 310 to adjust the drive potential of a new EC device 100 or for a user 320 to adjust the drive potential of an existing EC device 100. In one embodiment, the user 320 requests that the EC device 100 be tested, with the test results being reported by internal logic 640 to an external host 660 through network 650. In an alternate embodiment, the testing occurs autonomously, with the EC device 100 automatically reporting back to external host 660 over network 650. In yet another embodiment, external host 660 communicates with internal logic 640 over network 650 to cause testing of EC device 100 and application of the potential.

In above description, the embodiments comprise lowering the starting potential or lowering drive potential of an EC device. The same methods may be used to increase starting potential and drive potential by applying different values of potentials.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

Although the description above contains many specific examples, these should not be construed as limiting the scope of the invention but as merely providing illustrations of some of the presently preferred embodiments of this invention. Thus, the scope of the invention should be determined by the appended claims and their legal equivalents, rather than by the examples given.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/We claim:

1. A method for lowering the drive potential of an electrochromic device comprising a first electrode, a second electrode, and an electrolyte, the method comprising applying a potential between the first and second electrodes.

2. The method of claim 1, wherein the potential applied between the first and second electrodes is between approximately +/−0.1 and approximately +/−10 V.

3. The method of claim 2, wherein the potential applied between the first and second electrodes is between approximately +/−1.5 and approximately +/−3 V.

4. The method of claim 1, wherein the drive potential of the electrochromic device is lowered by a magnitude of at least approximately 10 mV.

5. The method of claim 4, wherein the drive potential of the electrochromic device is lowered by a magnitude of at least at least approximately 2 V.

6. The method of claim 1, wherein the first electrode comprises an electrochromic material; the second electrode comprises a bipolarisable material; and the potential applied between the first and second electrodes is between approximately +0.5 V and approximately +5 V.

7. A method of manufacturing an electrochromic device having a low drive potential, the method comprising:
(a) assembling a first electrode, a second electrode, and an electrolyte to form an electrochromic device; and
(b) applying a potential between the first and second electrodes to lower the drive potential of the electrochromic device.

8. The method of claim 7, wherein the potential applied between the first and second electrodes is between approximately +/−0.1 and approximately +/−10 V.

9. The method of claim 8, wherein the potential applied between the first and second electrodes is between approximately +/−1.5 and approximately +/−3 V.

10. The method of claim 7, wherein the drive potential of the electrochromic device is lowered by a magnitude of at least approximately 10 mV.

11. The method of claim 10, wherein the drive potential of the electrochromic device is lowered by a magnitude of at least approximately 2 V.

12. The method of claim 7, wherein the first electrode comprises an electrochromic material; the second electrode comprises a bipolarisable material; and the potential applied between the first and second electrodes is between approximately +0.5 V and approximately +5 V.

13. A method of manufacturing an electrochromic device, the method comprising:
(a) assembling a first electrode, a second electrode, and an electrolyte to form an electrochromic device; and
(b) incorporating computer software for applying a potential between the first and second electrodes to lower the drive potential of the electrochromic device.

14. The method of claim 13, wherein the potential applied between the first and second electrodes is between approximately +/−0.1 and approximately +/−10 V.

15. The method of claim 14, wherein the potential applied between the first and second electrodes is between approximately +/−1.5 and approximately +/−3 V.

16. The method of claim 13, wherein the drive potential of the electrochromic device is lowered by a magnitude of at least approximately 10 mV.

17. The method of claim 16, wherein the drive potential of the electrochromic device is lowered by a magnitude of at least approximately 2 V.

18. The method of claim 13, wherein the first electrode comprises an electrochromic material; the second electrode comprises a bipolarisable material; and the potential applied between the first and second electrodes is between approximately +0.5 V and approximately +5 V.

19. An electrochromic device having a low drive potential comprising a first electrode, a second electrode, an electrolyte, and means for applying a potential between the first and second electrodes.

20. The electrochromic device of claim 19, wherein the means for applying a potential between the first and second electrodes comprises computer software.

21. The electrochromic device of claim 19, wherein the potential applied between the first and second electrodes is between approximately +/−0.1 and approximately +/−10 V.

22. The electrochromic device of claim 21, wherein the potential applied between the first and second electrodes is between approximately +/−1.5 and approximately +/−3 V.

23. The electrochromic device of claim 19, wherein the drive potential is lowered by a magnitude of at least approximately 10 mV.

24. The electrochromic device of claim 23, wherein the drive potential is lowered by a magnitude of at least approximately 2 V.

25. The electrochromic device of claim 19, wherein the first electrode comprises an electrochromic material; the second electrode comprises a bipolarisable material; and the potential applied between the first and second electrodes is between approximately +0.5 V and approximately +5 V.

26. A method for lowering the overvoltage needed to operate an electrochromic device comprising a first electrode, a second electrode, and an electrolyte, the method comprising applying a potential greater than zero between the first and second electrodes.

27. The method of claim 26, wherein the magnitude of the potential applied between the first and second electrodes is greater than the magnitude of the normal drive potential used in the electrochromic device.

28. The method of claim 26, wherein the potential applied between the first and second electrodes is a varying waveform.

29. An electrochromic device having an adjustable starting potential comprising a first electrode, a second electrode, an electrolyte, and an electrical device for applying an electrical potential between the first and second electrodes.

30. The electrochromic device of claim 29 further comprising a detector.

31. The electrochromic device of claim 29 further comprising a tester.

32. The electrochromic device of claim 29 further comprising an internal logic unit.

33. A method of manufacturing an electrochromic device having a high contrast ratio at a low drive potential comprising a first electrode, a second electrode, and an electrolyte, the method comprising applying a potential greater than zero between the first and second electrodes.

34. A method of operating an optical device comprising:
(a) applying a potential to the optical device for a period of time sufficient to reduce an operating potential;
(b) measuring the contrast of the optical device to determine thereby if the operating potential has been sufficiently reduced; and
(c) reapplying the potential to the optical device if the operating potential has not been sufficiently reduced.

35. A method for changing the drive potential of an electrochromic device comprising a first electrode, a second electrode, and an electrolyte, the method comprising applying a potential between the first and second electrodes.

36. The method of claim 35 wherein said changing comprises increasing the drive potential.

37. The method of claim 35 wherein said applying a potential is performed for a period of time ranging between +/−3 milliseconds and 5 minutes.

38. A method for changing the drive potential of an electrochromic device comprising a first electrode, a second electrode, and an electrolyte; the method comprising temporarily subjecting at least part of the electrochromic device to one or more field forces, said field forces selected from the group consisting of a plasma, an electric field, a magnetic field, and combinations thereof.
